(19) United States
(12) Patent Application Publication
(10) Pub. No.: US 2025/0005865 A1
(43) Pub. Date: Jan. 2, 2025

(54) APPARATUS AND SYSTEM

(71) Applicant: Nokia Technologies Oy, Espoo (FI)

(72) Inventor: Tero Simo Ilari JOKELA, Tampere (FI)

(21) Appl. No.: 18/732,318

(22) Filed: Jun. 3, 2024

(30) Foreign Application Priority Data
Jun. 30, 2023 (GB) 2309970.8

(51) Int. Cl. G06T 19/00; G01S 7/51; G01S 17/89; G06T 17/00

(52) U.S. Cl. CPC G06T 19/00; G01S 7/51; G01S 17/89; G06T 17/00; G06T 2200/08; G06T 2200/24

(57) ABSTRACT

An apparatus comprising: a Light Detection and Ranging, LiDAR, transmitter for transmitting at least one first light signal; a LIDAR receiving means for receiving the at least one first light signal; a light receiving means for receiving at least one second light signal; decoding means for decoding the second light signal to obtain digital information encoded on the second light signal; and detection and ranging means for performing a detection and ranging operation based on receiving the at least one first light signal.

### TECHNOLOGICAL FIELD

Examples of the disclosure relate to an apparatus and system. Some relate to an apparatus and system for producing and updating a three-dimensional model using light signals.

### BACKGROUND

LIDAR (Light Detection and Ranging) is a method for determining ranges by targeting an object or a surface with a laser transmitter and measuring the time for the reflected light to return to the receiver. By combining measurements of several target points, a three-dimensional representation of the target object or surface can be created.

### BRIEF SUMMARY

According to various, but not necessarily all, examples there is provided an apparatus comprising: a Light Detection and Ranging, LiDAR, transmitter for transmitting at least one first light signal; a LiDAR receiving means for receiving the at least one first light signal; a light receiving means for receiving at least one second light signal; decoding means for decoding the second light signal to obtain digital information encoded on the second light signal; and detection and ranging means for performing a detection and ranging operation based on receiving the at least one first light signal.

In some but not necessarily all examples, the apparatus further comprises means for creating a three-dimensional model based on the detection and ranging operation; and means for displaying the three-dimensional model to a user of the apparatus.

In some but not necessarily all examples, the apparatus further comprises means for enabling user selection of one or more objects in the three-dimensional model.

In some but not necessarily all examples, the apparatus further comprises means for updating the three-dimensional model based on the obtained digital information.

In some but not necessarily all examples, the apparatus is configured to update the three-dimensional model in response to at least one of: decoding the second light signal; a determination that the three-dimensional model should be updated, the determination being based on a comparison of the information provided by the three-dimensional model and the obtained digital information; or a detection of a user input to the apparatus.

In some but not necessarily all examples, the decoding means is configured to: receive a plurality of second light signals with different directions of arrival; decode the plurality of second light signals to obtain respective digital information; and classify the obtained digital information into different groups based on a direction of arrival of the second light signals; and, optionally, wherein the decoding means is further configured to classify the obtained digital information into the different groups based on time division multiplexing and/or frequency division multiplexing.

In some but not necessarily all examples, the obtained digital information controls creation of a bidirectional communication channel 250 between the apparatus and another apparatus.

In some but not necessarily all examples, the apparatus further comprises means for determining if a direction of arrival of the second light signal corresponds to a bearing of a first object in the three-dimensional model,

wherein the means for updating the three-dimensional model are configured to augment the three-dimensional model, based upon a determination that the direction of arrival of the second light signal corresponds to the bearing of the first object, comprising associating the digital information with the first object in the three-dimensional model.

In some but not necessarily all examples, the apparatus further comprises means for determining if a range of the second light signal corresponds to a position of the first object in the three-dimensional model, wherein the means for updating the three-dimensional model are configured to augment the three-dimensional model, based upon a determination that the range of the second light signal corresponds to the position of the first object and the determination that the direction of arrival of the second light signal corresponds to the bearing of the first object, comprising associating the digital information with the first object in the three-dimensional model.

In some but not necessarily all examples, the apparatus further comprises means for determining if a bearing of a second object in the three-dimensional model correspond to the bearing of the first object; wherein the means for updating the three-dimensional model are configured to augment the three-dimensional model, based upon a determination that the bearing β of the second object corresponds to the bearing of the first object, comprising associating the digital information with the second object in the three-dimensional model.

In some but not necessarily all examples, the apparatus comprises means for determining if a position of the second object in the three-dimensional model corresponds to the position of the first object in the three-dimensional model; wherein the means for updating the three-dimensional model are configured to augment the three-dimensional model, based upon a determination that the position of the second object corresponds to the position of the first object and the determination that the bearing β of the second object corresponds to the bearing of the first object, comprising associating the digital information with the second object in the three-dimensional model.

In some but not necessarily all examples, the means for updating the three-dimensional model are further configured to selectively adapt at least one of the first object or the second object.

In some but not necessarily all examples, selectively adapting at least one of the first object or the second object comprises: determining that an alternative three-dimensional representation of the at least one of the first object or the second object is available for download; downloading the alternative three-dimensional representation of the at least one of the first object or the second object; and augmenting the three-dimensional model by placing the alternative three-dimensional representation of the at least one of the first object or the second object in the three-dimensional model.

In some but not necessarily all examples, selectively adapting at least one of the first object or the second object comprises: removing at least a portion of the at least one of the first object or the second object from the three-dimensional model; and/or obscuring at least a portion of the at least one of the first object or the second object.

According to various, but not necessarily all, examples there is provided an apparatus comprising: a light receiver for receiving at least one first light signal, means for digitally encoding a light signal with information to form an encoded second light signal; a transmitter for transmitting the encoded second light signal.

According to various, but not necessarily all, examples there is provided an apparatus comprising: a light receiver for receiving at least one first light signal; means for determining a direction of arrival of the received at least one first light signal; means for digitally encoding a light signal with information to form an encoded second light signal; and a transmitter for transmitting the encoded second light signal using a direction of departure that is reciprocal to the direction of arrival of the received at least one first light signal.

According to various, but not necessarily all, examples, there is provided a system comprising two apparatuses as described above.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

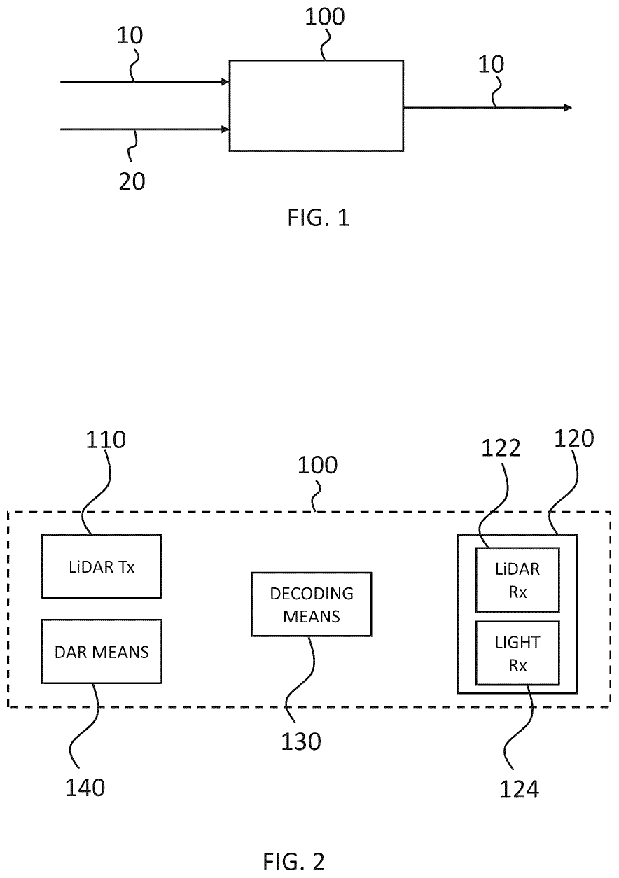

FIG. 1 shows an example of the subject-matter described herein;

FIG. 2 shows an example of the subject-matter described herein;

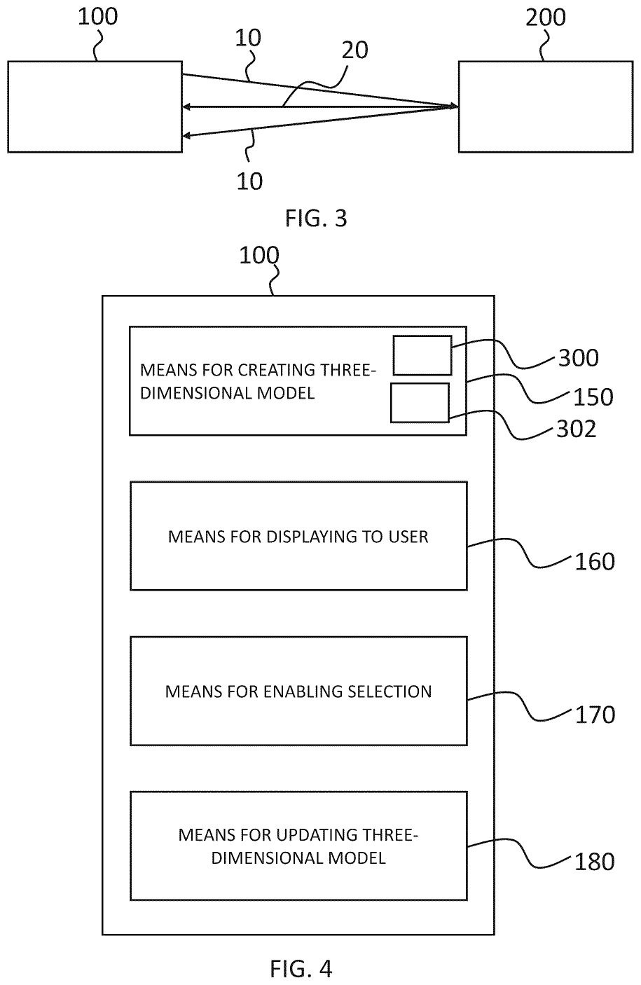

FIG. 3 shows an example of the subject-matter described herein;

FIG. 4 shows an example of the subject-matter described herein;

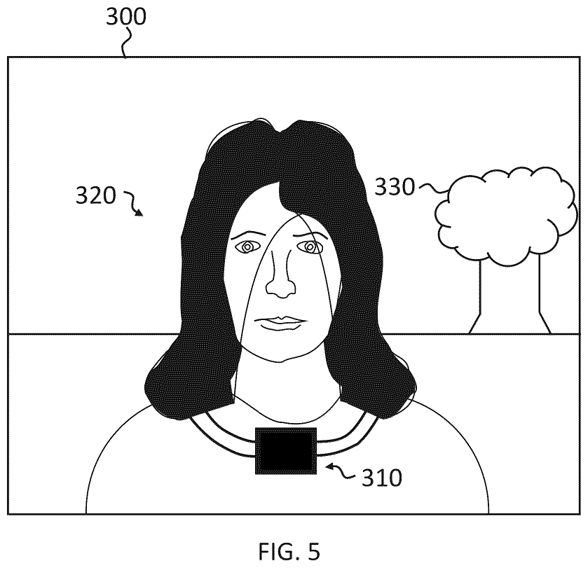

FIG. 5 shows an example of the subject-matter described herein;

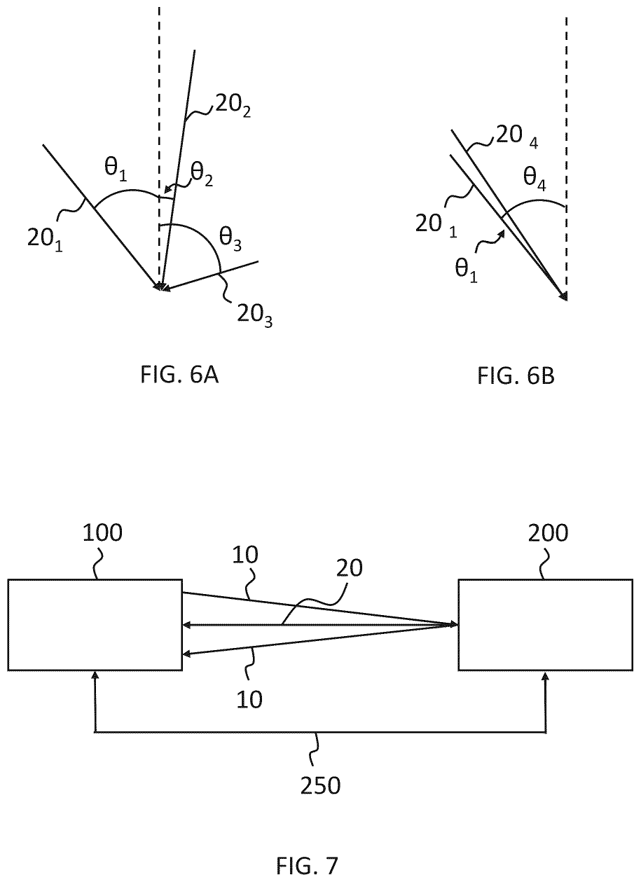

FIGS. 6A-6B shows an example of the subject-matter described herein;

FIG. 7 shows an example of the subject-matter described herein;

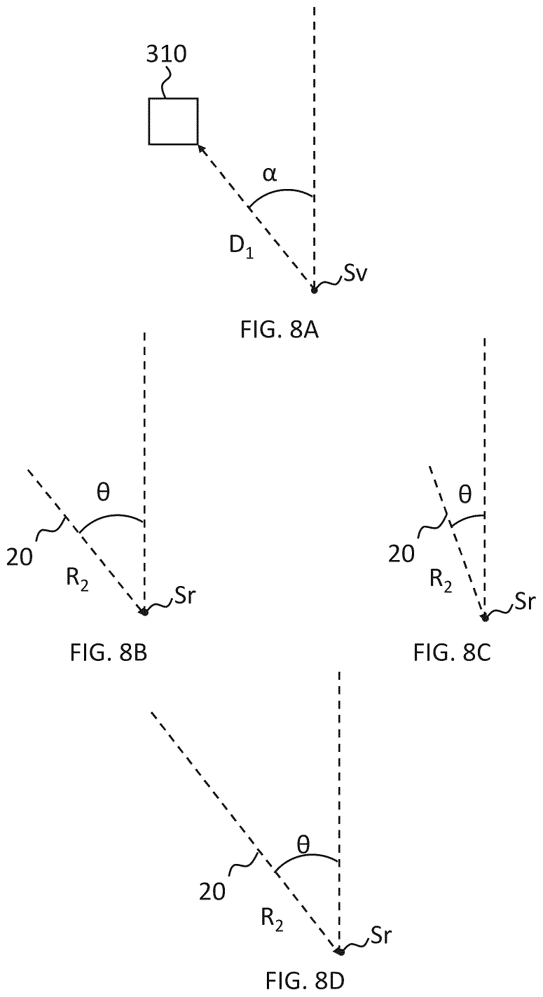

FIGS. 8A-8D shows an example of the subject-matter described herein;

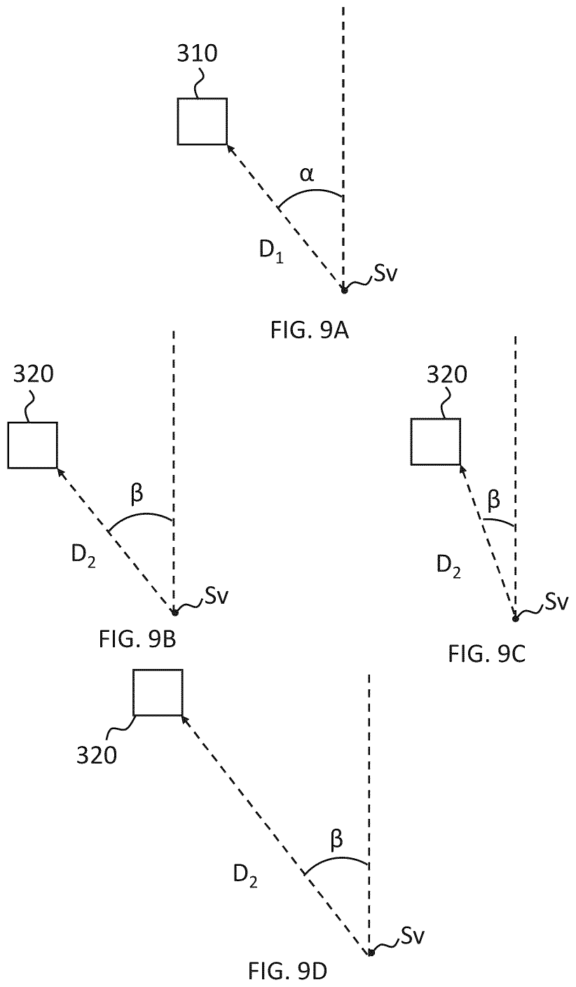

FIGS. 9A-9D shows an example of the subject-matter described herein;

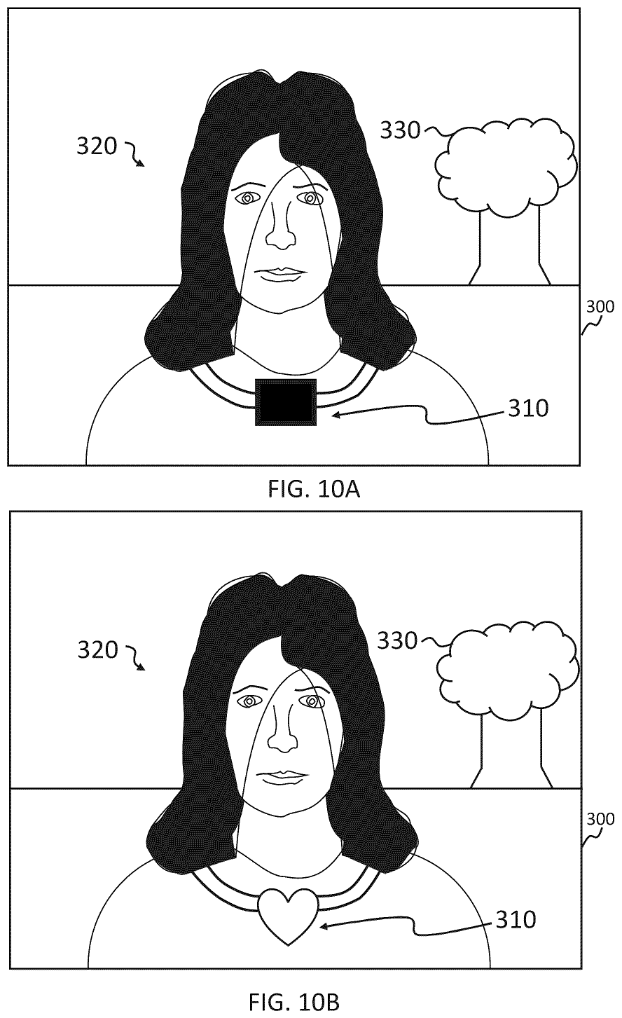

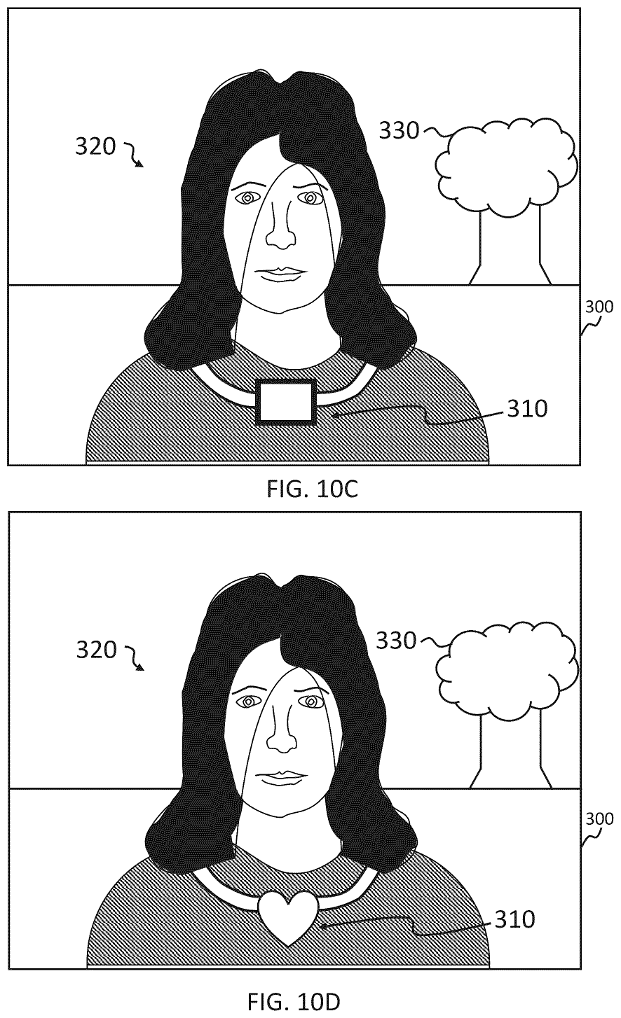

FIGS. 10A-10D shows an example of the subject-matter described herein;

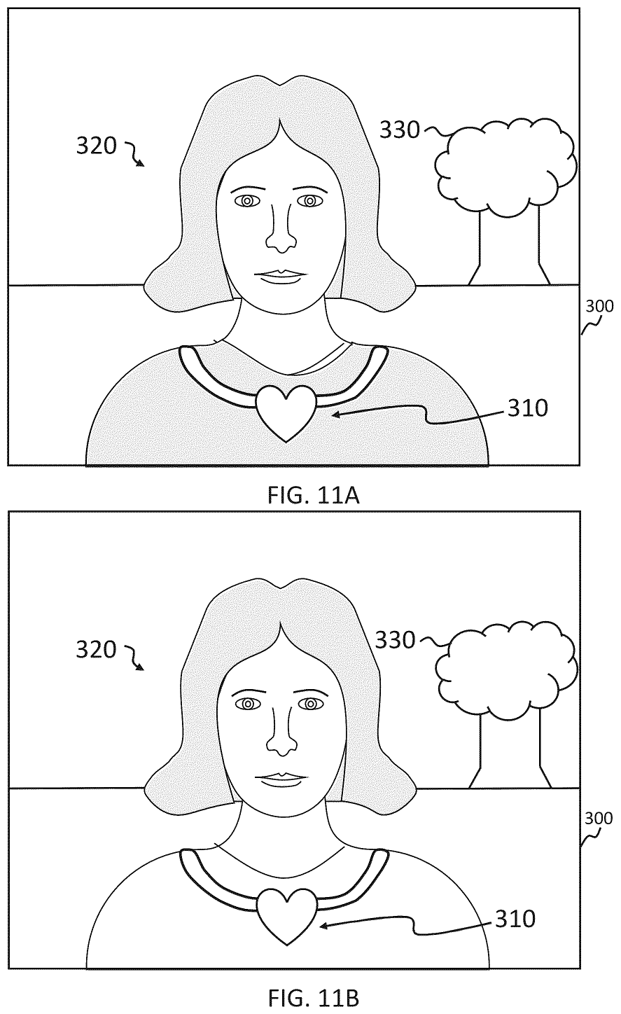

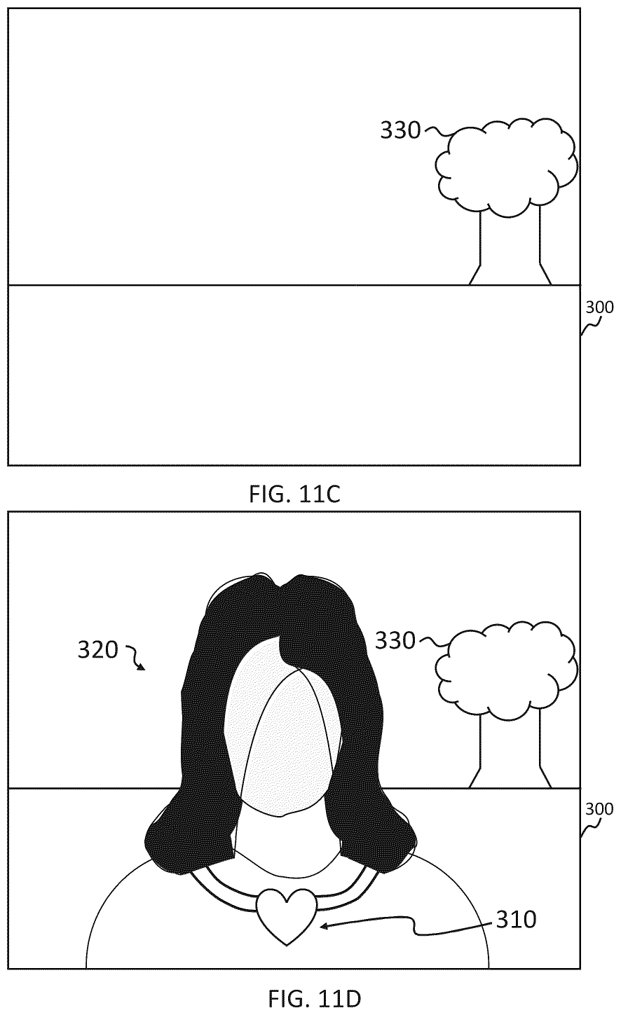

FIGS. 11A-11D shows an example of the subject-matter described herein;

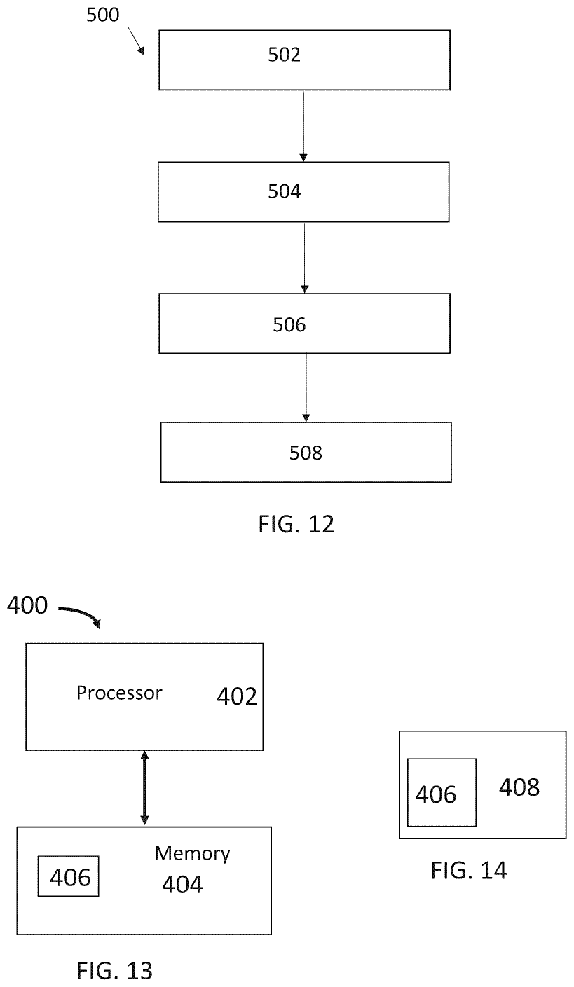

FIG. 12 shows an example of the subject-matter described herein;

FIG. 13 shows an example of the subject-matter described herein;

FIG. 14 shows an example of the subject-matter described herein;

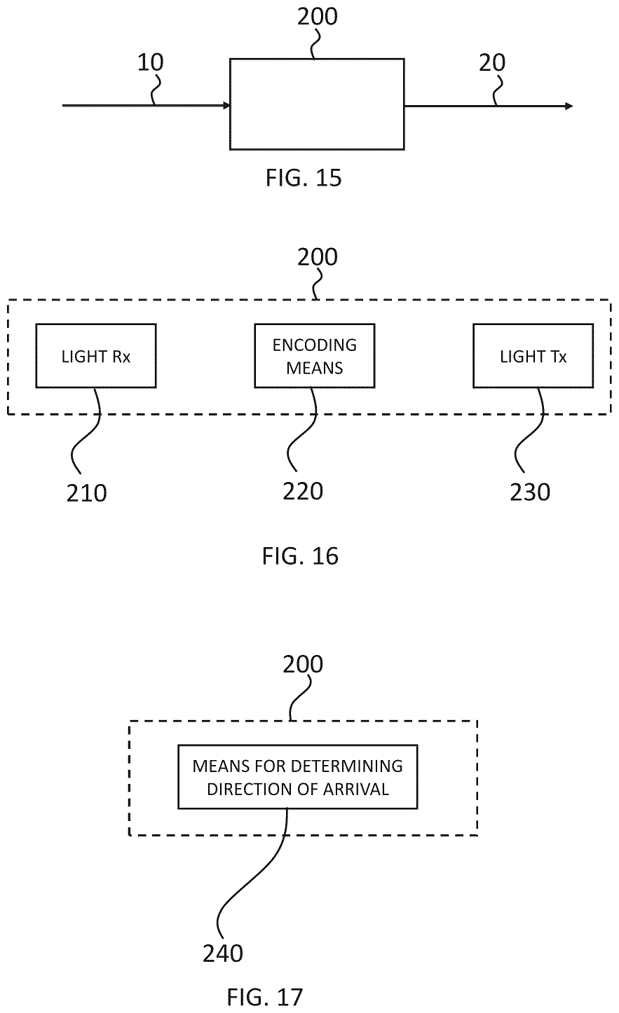

FIG. 15 shows an example of the subject-matter described herein;

FIG. 16 shows an example of the subject-matter described herein;

FIG. 17 shows an example of the subject-matter described herein;

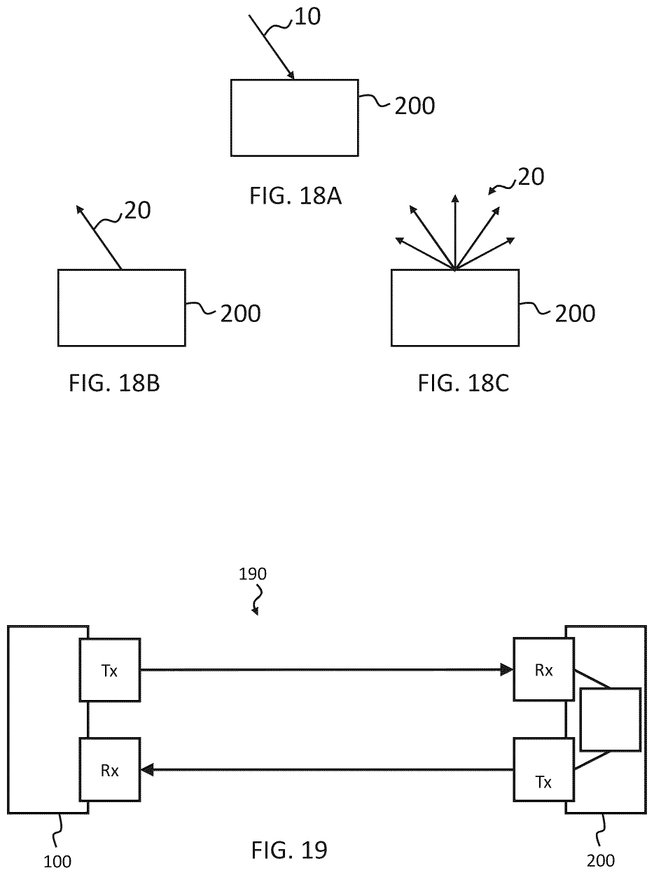

FIGS. 18A-18C shows an example of the subject-matter described herein;

FIG. 19 shows an example of the subject-matter described herein;

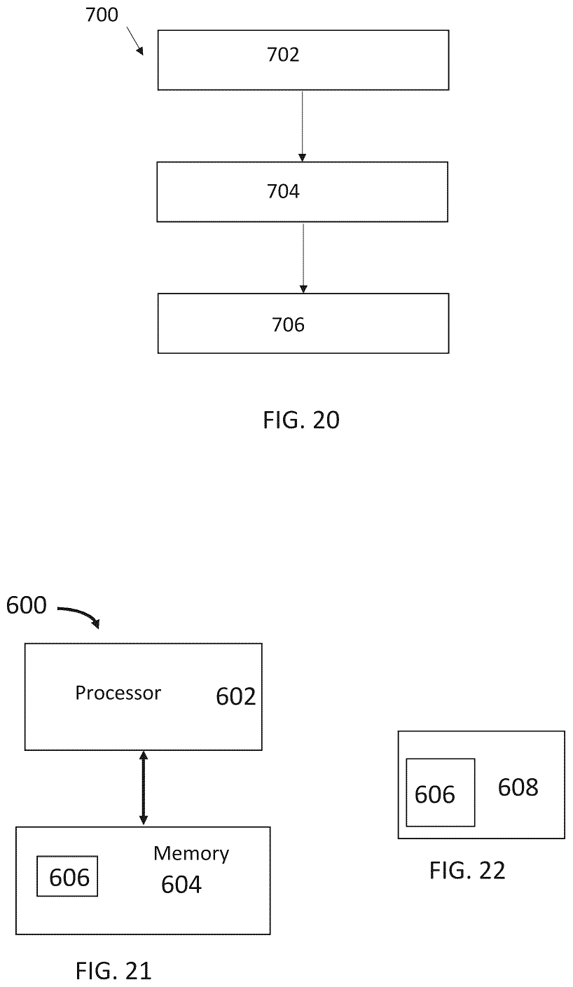

FIG. 20 shows an example of the subject-matter described herein;

FIG. 21 shows an example of the subject-matter described herein; and

FIG. 22 shows an example of the subject-matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

The following description, and the enclosed FIGs, relate to various examples of an apparatus 100 comprising:
a Light Detection and Ranging (LiDAR) transmitter 110 for transmitting at least one first light signal 10;
a LIDAR receiving means 122 for receiving the at least one first light signal 10; and
a light receiving means 124 for receiving at least one second light signal 20;
decoding means 130 for decoding the second light signal 20 to obtain digital information encoded on the second light signal 20; and
detection and ranging means 140 for performing a detection and ranging operation based on receiving the at least one first light signal 10.

The following description also relates to various examples of a second apparatus 200 comprising:
a light receiver 210 for receiving at least one first light signal 10;
means 220 for digitally encoding a light signal with information to form an encoded second light signal 20; and
a light transmitter 230 for transmitting the encoded second light signal 20.

The light signal is a light signal generated by the second apparatus 200. In examples, the light signal is not the first light signal.

The following description further relates to various examples of a system 190 comprising the apparatus 100 and the second apparatus 200.

FIG. 1 schematically illustrates an example of an apparatus 100.

The apparatus 100 is configured to transmit at least one first light signal 10, and to receive the at least one first light signal 10 and at least one second light signal 20.

In examples, the at least one first light signal 10 is reflected by an object before being received by the apparatus 100. The apparatus 100 thus performs a LIDAR scan of the object.

FIG. 2 illustrates a further example of the apparatus 100 illustrated in FIG. 1 and FIG. 3 illustrates features of the apparatus 100. Features not illustrated in FIG. 2 are illustrated in FIG. 3.

The apparatus 100 comprises a Light Detection and Ranging (LiDAR) transmitter 110 for transmitting at least one first light signal 10 (not illustrated in FIG. 2).

In examples, the at least one first light signal 10 is a laser signal. For example, the at least one first light signal 10 may be a laser pulse. In examples, the at least one first light signal 10 is invisible to the human eye. For example, the at least one first light signal 10 may have an infrared wavelength. In other examples, the at least one first light signal is visible to the human eye.

The apparatus 100 comprises a LIDAR receiving means 122 for receiving the at least one first light signal 10 and a light receiving means 124 for receiving at least one second light signal 20 (not illustrated in FIG. 2). In examples, such as the example illustrated in FIG. 2, the LiDAR receiving means 122 and the light receiving means 124 are provided as a single receiving means 120. The receiving means 120 thus comprises LiDAR receiving means 122 and light receiving means 124. In other examples, the LiDAR receiving means 122 and light receiving means 124 are provided as separate and distinct means.

The at least one first light signal 10, having been transmitted from the LiDAR transmitter 110, is reflected by an object before being received by the LiDAR receiving means 122. In examples, such as the example illustrated in FIG. 3, the at least one first light signal 10 is reflected by a second apparatus 200 before being received by the LiDAR receiving means 122.

The apparatus 100 determines a reflection time of the at least one first light signal 10. The reflection time of the at least one first light signal 10 is the period of time between the transmission of the at least one first light signal 10 by the LiDAR transmitter 110 and the reception of the reflected at least one first light signal 10 by the LiDAR receiving means 122. It is the time of flight (travel time) for the first light signal 10 to the reflecting object and back which can also be referred to as a ‘ranging time’.

In examples, the LiDAR transmitter 110 is configured to transmit multiple first light signals 10 and the LiDAR receiving means 122 is configured to receive the multiple first light signals 10 after reflection. In such examples, the multiple first light signals 10 have multiple, different directions of transmission and thus have multiple, different directions of arrival at the LiDAR receiving means 122. By transmitting and receiving multiple different first light signals 10, LIDAR scanning of an object and/or area is enabled.

The at least one second light signal 20 is a light signal transmitted by an apparatus separate from the apparatus 100. In examples, such as the example illustrated in FIG. 3, the at least one second light signal 20 is transmitted by the second apparatus 200.

In examples, the second apparatus 200 is configured to transmit the at least one second light signal 20 in response to receiving the at least one first light signal 10. The second apparatus 200 is thus an object that has been scanned in the LiDAR scan carried out by the LiDAR transmitter and LiDAR receiving means.

In examples, the at least one second light signal 20 is a laser signal. For example, the at least one second light signal 20 may be a laser pulse. In examples, the at least one second light signal 20 is invisible to the human eye. For example, the at least one second light signal 20 may have an infrared wavelength.

The second light signal 20 is a light signal on which digital information has been encoded. For example, the second apparatus 200 may encode the second light signal 20 with digital information. The digital information can, for example, be information relating to the second apparatus 200 and/or about an object associated with the second apparatus 200. An object may be associated with the second apparatus 200 if it overlaps, is attached to, or is otherwise in contact with or close proximity to the second apparatus 200. Additionally or alternatively, an object may be associated with the second apparatus 200 if it does not overlap, is not attached to, or is not otherwise in contact with or close proximity to the second apparatus 200. In some such examples, the digital information comprises information identifying the object and associating the object with the second apparatus 200.

In examples in which the second light signal 20 is transmitted by the second apparatus 200 in response to receiving the at least one first light signal 10, the digital information comprises an indication that the second light signal has been transmitted by the second apparatus 200 in response to receiving the at least one first light signal 10.

In examples, the digital information comprises identification information about the second apparatus 200 or the object associated with the second apparatus 200. For example, the digital information may comprise information identifying a class of the second apparatus 200 or the object associated with the second apparatus 200. In at least some examples, the digital information identifies the second apparatus 200 or the object associated with the second apparatus 200 as a person or a car.

The digital information may provide specific identifying information about the second apparatus 200 or the object associated with the second apparatus 200, for example, the digital information may provide a person's digital identity or device identity such as a car registration number.

The digital information may provide identifying information for the second apparatus 200 or the object associated with the second apparatus 200 which corresponds to a commercial standard, such as a Universal Product Code.

In examples, the digital information is encoded onto the at least one second light signal 20 by modulating the at least one second light signal 20. In examples, the digital information comprises binary data.

Referring back to FIG. 2, the apparatus 100 comprises decoding means 130 for decoding the second light signal 20 to obtain digital information encoded on the second light signal 20.

In examples, decoding the second light signal 20 comprises demodulating the second light signal 20 to obtain the digital information modulated thereon. In examples, the obtained digital information comprises binary data.

The apparatus 100 is thus able to obtain further information about the second apparatus 200 or the object associated with the second apparatus 200, based on the digital information which has been obtained by decoding one or more second light signals 20 which were transmitted by the second apparatus 200.

Referring back to FIG. 2, the apparatus 100 comprises detection and ranging means 140 for performing a detection and ranging operation based on receiving the at least one first light signal 10.

The detection and ranging means 140 uses the reflection time of the at least one first light signal 10 to determine the distance between the apparatus 100 and the object which has reflected the at least one first light signal 10. The reflection time is the time of flight of the first light signal 10 from the apparatus 100 to the reflecting object and back from the reflecting object to the apparatus 100.

The direction of arrival of the at least one first light signal 10 is used to determine a bearing of the object which has reflected the at least one first light signal 10 relative to the apparatus 100. In this way, information about the position of the object which has reflected the at least one first light signal 10 is determined.

In at least some examples, multiple first light signals 10 are reflected by the same object. In such examples, further information about the position and shape of the object which has reflected the multiple first light signals 10 is determined.

In at least some examples, multiple first light signals 10 are reflected by different objects. In such examples, information about the positions and shapes of the different objects which have reflected the multiple first light signals 10 are determined.

In at least some examples, the LiDAR receiving means 122 is configured to receive multiple first light signals 10 simultaneously. In such examples, the LiDAR receiving means 122 may comprise a sensor array, for example a two-dimensional sensor array.

The detection and ranging means thus provides a mapping (mapping 302 illustrated in FIG. 4) between real-world objects in a real space and virtual objects in a virtual space.

In examples, the apparatus 100 comprises a positioning means. The positioning means determines a position of the apparatus 100 in the real space. The apparatus 100 has a virtual position in the virtual space, corresponding to the position of the apparatus 100 in the real space. The mapping 302 maps a position of the apparatus 100 in the real space to a virtual position of the apparatus 100 in the virtual space and the virtual position of the apparatus 100 in the virtual space to a position of the apparatus 100 in the real space

FIG. 3 illustrates an example of the apparatus 100 as described with reference to FIGS. 1 and 2 in communication with an example second apparatus 200. Features not illustrated in FIG. 3 are illustrated in FIG. 2.

In the example of FIG. 3, the at least one first light signal 10 has a travel path. The at least one light signal 10 is transmitted by the LiDAR transmitter 110 of the apparatus 100, reflected by the second apparatus 200 and received by LiDAR receiving means 122 of the first apparatus 100.

The detection and ranging means 140 can determine, a time/length of the travel path and a directivity of the travel path. In at least some example, the directivity of the travel path is determined from a direction of departure (DoD) of the at least one first light signal 10 from the LiDAR transmitter 110. In at least some examples, the directivity of the travel path is determined from a detected direction of arrival (DoA) of the at least one first light signal 10 at the LiDAR receiving means 122.

Based on the reflection time of the at least one first light signal 10 and the direction of arrival of the at least one first light signal 10 at the LiDAR receiving means 122, the detection and ranging means 140 determines information about the position of the second apparatus 200 relative to the apparatus 100.

The at least one second light signal 20 is transmitted by the second apparatus 200 and received by the light receiving means 124 of the first apparatus 100. The decoding means 130 decodes the second light signal 20 to obtain digital information encoded on the second light signal 20. Further information about the second apparatus 200 is thus obtained.

FIG. 4 illustrates a further example of the apparatus 100 as described in any of the preceding FIGs. As shown in FIG. 4, the apparatus 100 may further comprise means 150 for creating a three-dimensional model 300 based on the detection and ranging operation; means 160 for displaying the three-dimensional model 300 to a user of the apparatus 100; and means 170 for enabling user-controlled selection of one or more objects in the three-dimensional model 300.

The means for creating a three-dimensional model 300 based on the detection and ranging operation creates the three-dimensional model 300 based on the mapping between objects in the real world and virtual objects in the virtual space that has been produced by the detection and ranging means.

FIG. 5 illustrates an example of a three-dimensional model 300. In the example of FIG. 5, three objects are illustrated: a first object 310 (in the example of FIG. 5, a necklace); a second object 320 (in the example of FIG. 5, a person); and a third object 330 (in the example of FIG. 5, a tree). The objects in the three-dimensional model 300 are virtual objects which are mapped from corresponding real-world objects which have been scanned by the apparatus 100.

In examples, the means 160 for displaying the three-dimensional model 300 to a user of the apparatus 100 comprise any means capable of providing a two-dimensional representation of a three-dimensional model 300, for example a screen, smart glasses, or a projector. In other examples, the means 160 for displaying the three-dimensional model 300 to a user of the apparatus 100 comprise any means capable of providing a three-dimensional representation of the three-dimensional model 300, for example a virtual reality apparatus 100.

The means 160 for displaying the three-dimensional model 300 to a user are configured to determine a point of view. In examples, the point of view is dependent upon the position of the apparatus and an orientation of the apparatus and/or a virtual position of the apparatus and a virtual orientation of the apparatus when the at least one first light signal 10 and the at least one second light signal 20 are received by the apparatus. In other examples, the point of view is dependent upon a position of the user and an orientation of the user and/or a virtual position of the user and a virtual orientation of the user.

The means 170 for enabling user selection of one or more objects in the three-dimensional model 300 may provide a user interface which enables a user of the apparatus 100 to control the display of the three-dimensional model 300, for example the user may be able to pan, zoom, and rotate the three-dimensional model 300 to enable viewing of different objects in the model.

The means 170 for enabling user selection of one or more objects in the three-dimensional model 300 may further provide a user interface which enables a user to edit the three-dimensional model 300. For example, the three-dimensional model 300 may be segmented such that the user is able to select a single object in the three-dimensional model 300, such as the second object 320. For example, the three-dimensional model 300 may be segmented as a grid, enabling user selection of one or more segments of the grid. For example, the three-dimensional model 300 may be segmented by object, for example nearby objects determined to have similar distances may be considered as a single object, enabling user selection of one or more objects. This may enable the user to move, remove, or otherwise change the appearance of various objects in the three-dimensional model 300.

In examples, the apparatus 100 further comprises means 180 for updating the three-dimensional model 300 based on the obtained digital information.

In examples, the means 180 for updating the three-dimensional model 300 are configured to update the three-dimensional model 300 in response to fulfilment of a trigger condition.

In examples, the trigger condition is the decoding of the second light signal 20. The means 180 for updating the three-dimensional model 300 may be configured to update the three-dimensional model 300 upon receiving an indication that the second light signal 20 has been decoded. The indication may be an indication that the decoding of the second light signal 20 has been completed.

In examples, the trigger condition is a determination that the three-dimensional model 300 should be updated, the determination being based on a comparison of the information provided by the three-dimensional model 300 and the obtained digital information.

In examples, the determination that the three-dimensional model 300 should be updated is a comparison of a quality parameter of the three-dimensional model 300 with a quality parameter of the obtained digital information. In examples, the quality parameter may be at least one of: an indication of a resolution of a model, an availability of a 360° representation of one or more objects in the model, or an age of the model.

In further examples, the determination could be based on an identified importance level of an object in the three-dimensional scan. If the obtained digital information provides information about an object that is deemed to be of high importance, it may be determined that the three-dimensional model 300 should be updated. If the obtained digital information provides information about an object that is deemed to be of low importance, it may be determined that the three-dimensional model 300 should not be updated.

In examples, the importance level of an object in the three-dimensional model 300 is determined based on a reference point. In examples, the reference point is the point of view. In other examples, the reference point is the scanning point Sr and/or the virtual scanning point Sv.

For example, if, when the three-dimensional model 300 viewed from the reference point, an object is in the foreground of the three-dimensional model or is below a threshold distance T from the point of view, such as the person 320 of FIG. 5, it may be deemed to be of high importance. For example, if, when viewed from the reference point, an object is in the background of the three-dimensional model or is equal to or above the threshold distance T from the point of view, such as the tree 330 of FIG. 5, it may be deemed to be of low importance. In such examples, if the decoded information provides information about the person 320, then it is determined that the three-dimensional model 300 should be updated, and if the decoded information provides information about the tree 330, then it is determined that the three-dimensional model 300 should not be updated.

In other examples, the importance level of an object in the three-dimensional scan is determined based on other parameters. For example, the importance level of an object may be based on any one or more of: distance from the reference point, angle relative to the reference point, or the quality parameter of the object.

In examples, the trigger condition is a detection of a user input to the apparatus 100. In some such examples, the user interface may provide a prompt to the user to indicate whether they wish to update the three-dimensional model 300. In other such examples, no prompt is provided, and the user may otherwise indicate that they wish to update the three-dimensional model 300.

In examples, the apparatus 100 is configured to receive a plurality of second light signals 20. The apparatus 100 may be configured to receive the plurality of second light signals 20 simultaneously and/or sequentially.

In examples, the light receiving means 124 has a resolution which enables differentiation of second light signals 20 which have a difference in direction of arrival θ of at least a threshold value γ. If the difference between the directions of arrival θ of two second light signals 20 is less than the threshold value γ, the light receiving means 124 cannot distinguish between the directions of arrival θ of the two second light signals 20.

FIG. 6A illustrates an example in which the plurality of second light signals 20₁, 20₂, 20₃ have directions of arrival θ₁, θ₂, θ₃ which may be differentiated by the light receiving means 124. For example, the differences between θ₁ and θ₂, θ₂ and θ₃, and θ₃ and θ₁ may each be equal to or more than the threshold value γ. In such examples, the decoding means 130 is configured to decode the plurality of second light signals 20₁, 20₂, 20₃ to obtain the respective digital information encoded on the plurality of second light signals 20₁, 20₂, 20₃, and to classify the obtained digital information into different groups based on the directions of arrival θ of the second light signals 20₁, 20₂, 20₃. In the example of FIG. 6A, information decoded from the second light signals 20₁, 20₂ and 20₃ may be classified into three groups, the first group being decoded from signals having a direction of arrival θ₁, the second group being decoded from signals having a direction of arrival θ₂, and the third group being decoded from signals having a direction of arrival θ₃.

FIG. 6B illustrates an example in which the plurality of second light signals 20₁, 20₄ have directions of arrival θ₁, 84 which may not be differentiated by the light receiving means. For example, the difference between θ₁ and θ₄ may be less than the threshold value γ. In such examples, the decoding means 130 is configured to decode the plurality of second light signals 20₁, 20₄ to obtain the respective digital information encoded on the plurality of second light signals 20₁, 20₄, and to classify the obtained digital information into different groups based on time division multiplexing and/or frequency division multiplexing.

In examples, the second light signal 20₁ has a different frequency to the second light signal 20₄, enabling the decoding means 130 to differentiate between the two light signals. In further examples, one of the second light signals 20₁, 20₄ is sent with a time delay, enabling the decoding means 130 to differentiate between the two light signals. The apparatus 100 is thus able to distinguish between multiple light signals with the same or similar directions of arrival θ.

Therefore, in the example of FIG. 6B, information decoded from the second light signals 20₁, 20₄ may be classified into two groups, the first group being decoded from second light signals 20 with a first frequency and/or a first time delay and the second group being decoded from second light signals 20 with a second frequency and/or a second time delay.

In examples, the decoding means 130 is configured to first attempt to differentiate the second light signals 20 based on their directions of arrival θ and, if it is unable to differentiate between some or all of the received second light signals 20 based on their directions of arrival θ, to then differentiate them based on time division multiplexing and/or frequency division multiplexing.

In examples, the obtained digital information controls creation of a bidirectional communication channel 250 between the apparatus 100 and another apparatus. FIG. 7 illustrates an example in which a bidirectional communication channel 250 is created between the apparatus 100 and the second apparatus 200.

In examples, the obtained digital information comprises a network address of the second apparatus 200, along with other parameters required to establish a data connection between the apparatus 100 and the second apparatus 200. In examples, the other parameters comprise any one or more of: user credentials (e.g., username, password), a network name (e.g., SSID), network authentication information (e.g., Wi-Fi pre-shared key), a communication protocol or scheme (e.g., HTTP), a network address of the other device (including port), a service endpoint (e.g., a URL path), service authentication information (e.g., an authentication token), and any application specific parameters.

In other examples, the obtained digital information may authenticate the connection between the apparatus 100 and the second apparatus 200. In this way, the one or more second light signals 20 provide an Out-of-Band channel for authentication.

The bidirectional communication channel 250 may be a high-bandwidth communication channel, for example a WiFi or Bluetooth communication channel.

For clarity of description, FIGS. 8A-8D are described with reference to one or more second light signals 20. However, it is to be appreciated that the processes described below may also be applied to one or more groups of second light signals 20.

For the purpose of FIGS. 8A-8D and 9A-9D, reference will be made to a scanning point Sr and a virtual scanning point Sv. The position of the apparatus 100 in real space at the time that one or more first signals 10 and/or one or more second signals 20 are received by the apparatus 100 is the scanning point Sr. The virtual position of the apparatus 100 in the virtual space at the time that one or more first signals and/or one or more second signals are received by the apparatus 100 is the virtual scanning point Sv.

In examples, the apparatus 100 comprises means for determining if a direction of arrival θ of the one or more second light signals 20 corresponds to a bearing α of a first object 310 in the three-dimensional model 300. In this way, means for determining if digital information obtained from the one or more second light signals 20 relates to the first object 310 in the three-dimensional model 300 is provided.

Based on the determination, the means 180 for updating the three-dimensional model 300 are configured to augment the three-dimensional model 300, comprising associating the digital information with the first object 310 in the three-dimensional model 300.

In examples, associating the digital information with the first object 310 in the three-dimensional model 300 includes adding the digital information to the metadata of the first object 310 in the three-dimensional model 300; displaying a label on the first object 310 in the three-dimensional model 300 including the information; and/or adapting the first object 310 in the three-dimensional model 300 using the digital information.

In examples, associating the digital information with the first object 310 in the three-dimensional model 300 may enable segmentation of the three-dimensional model 300 such that the first object 310 in the three-dimensional model 300 may be individually selected and modified. In some such examples, the digital information comprises an indication that the first object 310 in the three-dimensional model 300 represents a particular type of object, for example a person or a car. The shape of a person or a car may then be identified within the three-dimensional model 300 and boundaries of the first object 310 in the three-dimensional model 300 may be drawn around the identified shape. The first object 310 in the three-dimensional model 300 may then be individually selected and modified.

FIG. 8A illustrates an example of the first object 310 in the three-dimensional model 300. In the example of FIG. 8A, the first object 310 in the three-dimensional model 300 has a position defined by a bearing α and a distance D1 from the virtual scanning point Sv.

FIGS. 8B-8D illustrate examples of a second light signal 20. The second light signal 20 has a direction of arrival θ at the apparatus 100 and a range R which is a distance the second light signal 20 has travelled to the apparatus 100.

In examples, the range R is determined based on a time period between transmission of the second light signal 20 from a second apparatus 200 and reception of the second light signal 20 at the first apparatus 100. In some such examples, the digital information comprises information indicating a time of transmission of the second light signal 20 from the second apparatus 200. A clock of the second apparatus 200 is synchronized with a clock of the first apparatus 100 to ensure an accurate measurement of the time period between transmission of the second light signal 20 from the second apparatus 200 and reception of the second light signal 20 at the first apparatus 100.

In some examples in which the second light signal 20 is transmitted by the second apparatus 200 in response to receiving the at least one first light signal 10, the range R is determined based on half of a time period between transmission of the first light signal 10 from the first apparatus 100 and reception of the second light signal 20 at the first apparatus 100.

In other examples in which the second light signal 20 is transmitted by the second apparatus 200 in response to receiving the at least one first light signal 10, the range R is determined based on the reflection time of the received at least one first light signal. In some such examples, the digital information comprises an indication that the range R should be determined based on the reflection time of the received at least one first light signal. The received at least one first light signal is at least one first light signal which has a direction of arrival at the first apparatus which is similar to, or the same as, the direction of arrival θ at the first apparatus of the second light signal. For example, the digital information may comprise an indication of a threshold difference between the direction of arrival of the first light signal and the direction of arrival θ of the second light signal. If the difference between the direction of arrival of the first light signal and the direction of arrival θ of the second light signal is below the threshold difference, then the at least one first light signal is determined to be the received at least one first light signal.

In the example of FIGS. 8B and 8D, the direction of arrival θ of the second light signal 20 is equal to the bearing α of the first object 310. It may therefore be determined that a direction of arrival θ of the second light signal 20 corresponds to a bearing α of a first object 310 in the three-dimensional model 300.

In examples, it may be determined that the direction of arrival θ of the second light signal 20 corresponds to the bearing α of the first object 310 in the three-dimensional model 300 when the direction of arrival θ of the second light signal 20 is not equal to the bearing α of the first object 310. For example, if a difference between the direction of arrival θ of the second light signal 20 and the bearing α of the first object 310 in the three-dimensional model 300 is lower than a threshold. The threshold may be ±5°, ±10°, or a threshold below which the apparatus 100 is not able to differentiate between the directions of arrival.

In examples, a determination that the direction of arrival θ of the second light signal 20 corresponds to a bearing α of a first object 310 in the three-dimensional model 300 indicates that the second light signal 20 comprises information relating to the first object 310 in the three-dimensional model 300.

Based upon the determination that the direction of arrival θ of the second light signal 20 corresponds to the bearing α of the first object 310 in the three-dimensional model 300, the means 180 for updating the three-dimensional model 300 are configured to augment the three-dimensional model 300, comprising associating the digital information with the first object 310 in the three-dimensional model 300.

In the example of FIG. 8C, the direction of arrival θ of the second light signal 20 is not equal to the bearing α of the first object 310. It may therefore be determined that a direction of arrival θ of the second light signal 20 does not correspond to a bearing α of the first object 310 in the three-dimensional model. In such examples, the means 180 for updating the three-dimensional model 300 do not augment the three-dimensional model 300 by associating the digital information with the first object 310 in the three-dimensional model 300.

In further examples, the apparatus 100 comprises, in addition, means for determining if a range R of the second light signal 20 corresponds to the distance D1 from the virtual scanning point Sv of the first object 310 in the three-dimensional model 300.

In examples, the apparatus 100 is configured to determine if the direction of arrival θ of the second light signal 20 corresponds to the bearing α of the first object 310 in the three-dimensional model 300 and also to determine if a range R of the second light signal 20 corresponds to the distance D1 from the virtual scanning point Sv of the first object 310 in the three-dimensional model 300. In such examples, the means 180 for updating the three-dimensional model 300 augment the three-dimensional model 300 if both the direction of arrival θ and the range R of the second light signal 20 correspond to the bearing α and the distance D1 from the virtual scanning point Sv of the first object 310 in the three-dimensional model 300 respectively.

In the example of FIG. 8B, the direction of arrival θ of the second light signal 20 is equal to the bearing α of the first object 310 and the range R of the second light signal 20 is equal to the distance D1 from the virtual scanning point Sv of the first object 310 in the three-dimensional model 300. It may therefore be determined that the direction of arrival θ of the second light signal 20 corresponds to the bearing α of the first object 310 in the three-dimensional model 300 and that the range R of the second light signal 20 corresponds to the distance D1 from the virtual scanning point Sv of the first object 310 in the three-dimensional model 300.

In examples, it may be determined that the range R of the second light signal 20 corresponds to the distance D1 from the virtual scanning point Sv of the first object 310 in the three-dimensional model 300 when the range R of the second light signal 20 is not equal to the distance D1 from the virtual scanning point Sv of the first object 310 in the three-dimensional model 300. For example, if a difference between the range R of the second light signal 20 and the distance D1 from the virtual scanning point Sv of the first object 310 in the three-dimensional model 300 is lower than a threshold. The threshold may be ±10 mm, ±50 mm, or a threshold below which the apparatus 100 is not able to differentiate between distances.

In examples, a determination that the direction of arrival θ of the second light signal 20 corresponds to the bearing α of the first object 310 in the three-dimensional model 300 and that the range R of the second light signal 20 corresponds to the distance D1 from the virtual scanning point Sv of the first object 310 in the three-dimensional model 300 indicates that the second light signal 20 comprises information relating to the first object 310 in the three-dimensional model 300.

Based upon the determination that the direction of arrival θ of the second light signal 20 corresponds to the bearing α of the first object 310 in the three-dimensional model 300 and that the range R of the second light signal 20 corresponds to the distance D1 from the virtual scanning point Sv of the first object 310 in the three-dimensional model 300, the means 180 for updating the three-dimensional model 300 are configured to augment the three-dimensional model 300, comprising associating the digital information with the first object 310 in the three-dimensional model 300.

In the example of FIG. 8D, the direction of arrival θ of the second light signal 20 is equal to the bearing α of the first object 310 but the range R of the second light signal 20 is not equal to the distance D1 from the virtual scanning point Sv of the first object 310 in the three-dimensional model 300. It may therefore be determined that the direction of arrival θ of the second light signal 20 corresponds to the bearing α of the first object 310 in the three-dimensional model 300 and that the range R of the second light signal 20 does not correspond to the distance D1 from the virtual scanning point Sv of the first object 310 in the three-dimensional model 300 In such examples, the means 180 for updating the three-dimensional model 300 do not augment the three-dimensional model 300 by associating the digital information with the first object 310 in the three-dimensional model 300.

In examples, the apparatus 100 comprises means for determining if a bearing β of a second object 320 in the three-dimensional model 300 corresponds to the bearing α of the first object 310. It may thus be determined if the digital information associated with the first object 310 in the three-dimensional model 300 should also be associated with the second object 320 in the three-dimensional model 300.

Based on the determination, the means 180 for updating the three-dimensional model 300 are configured to augment the three-dimensional model 300, comprising associating the digital information with the second object 320 in the three-dimensional model 300.

In examples, associating the digital information with the second object 320 in the three-dimensional model 300 includes a least one of: adding the digital information to the metadata of the second object 320 in the three-dimensional model 300; displaying a label on the second object 320 in the three-dimensional model 300 including the information; and/or adapting the second object 320 in the three-dimensional model 300 using the digital information.

In examples, associating the digital information with the second object 320 in the three-dimensional model 300 may enable segmentation of the three-dimensional model 300 such that the second object 320 in the three-dimensional model 300 may be individually selected and modified. In some such examples, the digital information comprises an indication that the second object 320 in the three-dimensional model 300 represents a particular type of object, for example a person or a car. The shape of a person or a car may then be identified within the three-dimensional model 300 and boundaries of the second object 320 in the three-dimensional model 300 may be drawn around the identified shape. The second object 320 in the three-dimensional model 300 may then be individually selected and modified.

In examples, one or more second light signals 20 are associated with the first object 310 in the three-dimensional model 300 and no second light signals 20 are associated with the second object 320 in the three-dimensional model 300. For example, the first object 310 in the three-dimensional model 300 may be an example of the second apparatus 200 which is capable of transmitting one or more second light signals, and the second object 320 in the three-dimensional model 300 is not capable of transmitting one or more second light signals. In some such examples, information decoded from the second light signals associated with the first object 310 in the three-dimensional model 300 also comprise information relating to the second object 320 in the three-dimensional model 300.

The means for determining if a bearing of the second object 320 in the three-dimensional model 300 corresponds to the bearing α of the first object 310 in the three-dimensional model 300 therefore enable a determination of whether the digital information obtained from the one or more second light signals related to the first object 310 also relates to the second object 320 in the three-dimensional model 300.

FIG. 9A illustrates an example of the first object 310 in the three-dimensional model 300. In the example of FIG. 9A, the first object 310 in the three-dimensional model 300 has a position defined by a bearing α and a distance D1 from the virtual scanning point Sv.

FIGS. 9B-9D illustrate examples of the second object 320 in the three-dimensional model 300. The second object 320 in the three-dimensional model 300 has a position defined by a bearing β and a distance from the virtual scanning point Sv.

In the examples of FIGS. 9B and 9D, the bearing β of the second object 320 in the three-dimensional model 300 is equal to the bearing α of the first object 310 in the three-dimensional model 300. It may therefore be determined that the bearing of the second object 320 in the three-dimensional model 300 corresponds to the bearing α of the first object 310 in the three-dimensional model 300.

In examples, it may be determined that the bearing of the second object 320 in the three-dimensional model 300 corresponds to the bearing α of the first object 310 in the three-dimensional model 300 when the bearing of the second object 320 in the three-dimensional model 300 is not equal to the bearing α of the first object 310 in the three-dimensional model 300. For examples, if a difference between the bearing of the second object 320 in the three-dimensional model 300 and the bearing α of the first object 310 in the three-dimensional model 300 is lower than a threshold. The threshold may be ±5°, ±10°, or a threshold below which the apparatus 100 is not able to differentiate between the directions of arrival.

In examples, a determination that the bearing of the second object 320 in the three-dimensional model 300 corresponds to the bearing α of the first object 310 in the three-dimensional model 300 indicates that the digital information relating to the first object 310 in the three-dimensional model 300 also relates to the second object 320 in the three-dimensional model 300.

Based upon the determination that the bearing of the second object 320 in the three-dimensional model 300 corresponds to the bearing α of the first object 310 in the three-dimensional mode, the means 180 for updating the three-dimensional model 300 are configured to augment the three-dimensional model 300, comprising associating the digital information with the second object 320 in the three-dimensional model 300.

In the example of FIG. 9C, the bearing of the second object 320 in the three-dimensional model 300 is not equal to the bearing α of the first object 310 in the three-dimensional model 300. It may therefore be determined that the bearing of the second object 320 in the three-dimensional model 300 does not correspond to the bearing α of the first object 310 in the three-dimensional model 300. In such examples, the means 180 for updating the three-dimensional model 300 do not augment the three-dimensional model 300 by associating the digital information with the second object 320 in the three-dimensional model 300.

In further examples, the apparatus 100 comprises means for determining if the distance from the virtual scanning point Sv of the second object 320 in the three-dimensional model 300 corresponds to the distance D1 from the virtual scanning point Sv of the first object 310 in the three-dimensional model 300.

In examples, the apparatus 100 is configured to determine if the bearing of the second object 320 in the three-dimensional model 300 corresponds to the bearing α of the first object 310 in the three-dimensional model 300 and also to determine if the distance from the virtual scanning point Sv of the second object 320 in the three-dimensional model 300 corresponds to the distance D1 from the virtual scanning point Sv of the first object 310 in the three-dimensional model 300. In such examples, the means 180 for updating the three-dimensional model 300 augment the three-dimensional model 300 if both the bearing and the distance from the virtual scanning point Sv of the second object 320 correspond to the bearing α and the distance D1 from the virtual scanning point Sv of the first object 310 in the three-dimensional model 300 respectively.

In the example of FIG. 9B, the bearing of the second object 320 is equal to the bearing α of the first object 310 and the distance D2 from the virtual scanning point Sv of the second object 320 is equal to the distance D1 from the virtual scanning point Sv of the first object 310. It may therefore be determined that the bearing of the second object 320 corresponds to the bearing α of the first object 310 and the distance D2 from the virtual scanning point Sv of the second object 320 corresponds to the distance D1 from the virtual scanning point Sv of the first object 310.

In examples, it may be determined that the distance from the virtual scanning point Sv of the second object 320 corresponds to the distance D1 from the virtual scanning point Sv of the first object 310 when the distance from the virtual scanning point Sv of the second object 320 is not equal to the distance D1 from the virtual scanning point Sv of the first object 310. For example, if a difference between the distance from the virtual scanning point Sv of the second object 320 and the distance D1 from the virtual scanning point Sv of the first object 310 is lower than a threshold. The threshold may be ±10 mm, ±50 mm, or a threshold below which the apparatus 100 is not able to differentiate between distances.

In examples, a determination that the bearing of the second object 320 corresponds to the bearing α of the first object 310 in the three-dimensional model 300 and that the distance from the virtual scanning point Sv of the second object 320 corresponds to the distance D1 from the virtual scanning point Sv of the first object 310 in the three-dimensional model 300 indicates that the second light signal 20 comprises information relating to the second object 320 in the three-dimensional model 300.

Based upon the determination that the bearing of the second object 320 corresponds to the bearing α of the first object 310 in the three-dimensional model 300 and that the distance from the virtual scanning point Sv of the second object 320 corresponds to the distance D1 from the virtual scanning point Sv of the first object 310 in the three-dimensional model 300, the means 180 for updating the three-dimensional model 300 are configured to augment the three-dimensional model 300, comprising associating the digital information with the second object 320 in the three-dimensional model 300.

In the example of FIG. 9D, the bearing of the second object 320 corresponds to the bearing α of the first object 310 but the distance from the virtual scanning point Sv of the second object 320 does not correspond to the distance D1 from the virtual scanning point Sv of the first object 310. It may therefore be determined that the bearing of the second object 320 corresponds to the bearing α of the first object 310 in the three-dimensional model 300 and that the distance from the virtual scanning point Sv of the second object 320 does not correspond to the distance D1 from the virtual scanning point Sv of the first object 310 in the three-dimensional model 300. In such examples, the means 180 for updating the three-dimensional model 300 do not augment the three-dimensional model 300 by associating the digital information with the second object 320 in the three-dimensional model 300.

In examples, the means 180 for updating the three-dimensional model 300 are configured to selectively adapt at least one of the first object 310 or the second object 320.

In examples, adapting at least one of the first object 310 or the second object 320 comprises panning, rotating, scaling, or otherwise modifying the appearance of the at least one of the first object 310 or the second object 320. Adapting at least one of the first object 310 or the second object 320 may alternatively or additionally comprise replacing the first object 310 or the second object 320 with a different object.

In examples, selectively adapting at least one of the first object 310 or the second object 320 comprises adapting the at least one of the first object 310 or the second object 320 in response to a selection of the at least one of the first object 310 or the second object 320. In examples, selection is automatic, for example in response to segmenting the three-dimensional model 300 or decoding new information about the at least one of the first object 310 or the second object 320. In other examples, selection is in response to a user input to the apparatus 100.

FIGS. 10A-10D illustrate an example three-dimensional model 300 comprising at least a first object 310, a second object 320 and a third object 330.

In the example of FIG. 10A, none of the first object 310, the second object 320 or the third object 330 have been selectively adapted.

FIG. 10B illustrates a three-dimensional model 300 in which the first object 310 has been selectively adapted and the second object 320 and the third object 330 have not been selectively adapted. In the example of FIG. 10B, the first object 310 has been adapted by changing the shape of the first object 310; however, the first object 310 could additionally or alternatively be selectively adapted using any of the methods described above.

FIG. 10C illustrates a three-dimensional model 300 in which the second object 320 has been selectively adapted and the first object 310 and the third object 330 have not been selectively adapted. In the example of FIG. 10C, the second object 320 has been adapted by changing the colour and pattern of a portion of the second object 320; however, the second object 320 could additionally or alternatively be selectively adapted using any of the methods described above.

FIG. 10D illustrates a three-dimensional model 300 in which the first object 310 and the second object 320 have been selectively adapted and the third object 330 has not been selectively adapted. In the example of FIG. 10D, the first object 310 has been adapted by changing the shape of the first object 310 and the second object 320 has been adapted by changing the colour and pattern of a portion of the second object 320; however, the first object 310 and the second object 320 could additionally or alternatively be selectively adapted using any of the methods described above.

None of FIGS. 10A-10D illustrate selective adaptation of the third object 330; however, it is to be appreciated that any or all objects in the three-dimensional model 300 may be selectively adapted.

In examples, selectively adapting at least one of the first object 310 or the second object 320 comprises: determining that an alternative three-dimensional representation of the at least one of the first object 310 or the second object 320 is available for download; downloading the alternative three-dimensional representation of the at least one of the first object 310 or the second object 320; and augmenting the three-dimensional model 300 by placing the alternative three-dimensional representation of the at least one of the first object 310 or the second object 320 in the three-dimensional model 300.

In examples, an alternative three-dimensional representation of the at least one of the first object 310 or the second object 320 comprises a pre-existing 360° scan or representation of the at least one of the first object 310 or the second object 320.

In such examples, the obtained digital information may comprise the alternative three-dimensional representation of the at least one of the first object 310 or the second object 320. In examples, the alternative three-dimensional representation of the at least one of the first object 310 or the second object 320 comprises a high-quality model; a flattering model; an artistic representation of the object; or a model of the object with some details removed.

In other such examples, the obtained digital information may comprise an indication that an alternative three-dimensional representation of the at least one of the first object 310 or the second object 320 is available for download. For example, a 360° scan or representation of the at least one of the first object 310 or the second object 320 may already have been produced.

In examples, downloading the alternative three-dimensional representation of the at least one of the first object 310 or the second object 320 may comprise receiving the alternative three-dimensional representation of the at least one of the first object 310 or the second object 320 directly from the second apparatus 200. In such examples, the object may be decoded from the second light signal 20, decoded from a further second light signal 20 received after the indication that the alternative three-dimensional representation of the at least one of the first object 310 or the second object 320 is available, or received via the bidirectional communication channel. The downloading may be automatic based upon the determination, or it may be in response to a request signal being sent from the apparatus 100 to the second apparatus 200.

In examples, downloading the alternative three-dimensional representation of the at least one of the first object 310 or the second object 320 comprises downloading the alternative three-dimensional representation of the at least one of the first object 310 or the second object 320 from the internet.

The three-dimensional model 300 is augmented by placing the alternative three-dimensional representation of the at least one of the first object 310 or the second object 320 in the three-dimensional model 300.

In examples, such as the example illustrated in FIG. 11A, the alternative three-dimensional representation of the at least one of the first object 310 or the second object 320 replaces the at least one of the first object 310 or the second object 320. The at least one of the first object 310 or the second object 320 is removed from the three-dimensional model 300 and the alternative three-dimensional representation is placed in the three-dimensional model 300 in the position of the at least one of the first object 310 or the second object 320. In the example of FIG. 11a, it is determined that an existing three-dimensional model 300 of the person has been created. This existing three-dimensional model 300 replaces the representation of the person obtained by the direction and ranging means 140.

In examples, such as the example illustrated in FIG. 11B, the alternative three-dimensional representation of the at least one of the first object 310 or the second object 320 is merged with the at least one of the first object 310 or the second object 320. A portion of the at least one of the first object 310 or the second object 320 is removed from the three-dimensional model 300 and a portion of the alternative three-dimensional representation is placed in the three-dimensional model 300 in the position of the removed portion of the at least one of the first object 310 or the second object 320. In the example of FIG. 11B, it is determined that an existing three-dimensional model 300 of the person has been created. Only a portion of the person (the head and hair) is replaced with the existing three-dimensional model 300; the remaining portion of the person remains in the three-dimensional model 300.

FIG. 11C illustrates an example in which selectively adapting at least one of the first object 310 or the second object 320 comprises removing at least a portion of the at least one of the first object 310 or the second object 320 from the three-dimensional model 300.

In examples, the obtained digital information comprises an indication that the object should not be included in the three-dimensional model 300. In such examples, selectively adapting at least one of the first object 310 or the second object 320 comprises removing at least a portion of the at least one of the first object 310 or the second object 320 from the three-dimensional model 300.

FIG. 11D illustrates an example in which selectively adapting at least one of the first object 310 or the second object 320 comprises obscuring at least a portion of the at least one of the first object 310 or the second object 320.

In examples, the obtained digital information may comprise an indication that the object should not be fully included in the three-dimensional model 300. For example, the information may comprise an indication of a maximum permitted resolution of the object, or of features that should be removed or blurred. In such examples, selectively adapting at least one of the first object 310 or the second object 320 comprises obscuring at least a portion of the object.

In examples, obscuring the object comprises blurring the object, removing some features of the object, or adding a filter to the object. In the example of FIG. 11D, the person's face is obscured so that they remain within the three-dimensional model but are not identifiable.

FIG. 12 illustrates an example of a method 500, the method comprising:
at block 502, transmitting at least one first light signal;
at block 504, receiving the at least one first light signal and receiving at least one second light signal;
at block 506, decoding the second light signal to obtain digital information encoded on the second light signal; and
at block 508, performing a direction and ranging operation based on receiving the at least one first light signal.

FIG. 13 illustrates an example of a controller 400 suitable for use in an apparatus 100. Implementation of a controller 400 may be as controller circuitry. The controller 400 may be implemented in hardware alone, have certain aspects in software including firmware alone or can be a combination of hardware and software (including firmware).

As illustrated in FIG. 13 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 100 when loaded into the processor 402. The computer program instructions, of the computer program 406, provide the logic and routines that enables the apparatus 100 to perform the methods illustrated in the accompanying Figs. The processor 402 by reading the memory 404 is able to load and execute the computer program 406.

The apparatus 100 comprises:
at least one processor 402; and
at least one memory 404 including computer program code
the at least one memory 404 and the computer program code configured to, with the at least one processor 402, cause the apparatus 100 at least to perform:
   transmitting at least one first light signal;
   receiving the at least one first light signal;
   receiving at least one second light signal;
   decoding the second light signal to obtain digital information encoded on the second light signal; and
   performing a detection and ranging operation based on receiving the at least one first light signal.

The apparatus 100 comprises:
at least one processor 402; and
   at least one memory 404 storing instructions that, when executed by the at least one processor 402, cause the apparatus at least to:
   transmit at least one first light signal;
   receive the at least one first light signal;
   receive at least one second light signal;
   decode the second light signal to obtain digital information encoded on the second light signal; and
   perform a detection and ranging operation based on receiving the at least one first light signal.

As illustrated in FIG. 14, the computer program 406 may arrive at the apparatus 100 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 100 may propagate or transmit the computer program 406 as a computer data signal.

Computer program instructions for causing an apparatus to perform at least the following or for performing at least the following:
transmitting at least one first light signal;
receiving the at least one first light signal;
receiving at least one second light signal;
decoding the second light signal to obtain digital information encoded on the second light signal; and
performing a detection and ranging operation based on receiving the at least one first light signal.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

FIG. 15 illustrates a further example of the second apparatus 200 illustrated in FIG. 3. FIG. 16 illustrates features of the second apparatus 200. Features not illustrated in FIG. 16 are illustrated in FIG. 15.

As shown in FIG. 15, the second apparatus 200 is configured to receive at least one first light signal 10 and to transmit at least one encoded second light signal 20.

In examples, the at least one first light signal 10 is a first light signal 10 as described above. In examples, the at least one first light signal 10 is a LIDAR signal transmitted by a separate apparatus such as the apparatus 100 described above.

In examples, the encoded second light signal 20 is a second light signal 20 as described above.

Referring to FIG. 16, the second apparatus 200 comprises a light receiver 210 for receiving at least one first light signal 10. In some examples, the second apparatus 200 comprises more than one light receiver 210 for receiving more than one first light signal 10.

In examples, the light receiver 210 provides an indication that at least one first light signal 10 has been received.

FIG. 17 illustrates a further example of the second apparatus 200 as illustrated in any of FIGS. 3, 15 and 16. In the example of FIG. 17, the second apparatus 200 comprises means 240 for determining a direction of arrival of the received at least one first light signal 10.

In examples, the second apparatus 200 comprises a processor. The processor receives the indication that at least one first light signal 10 has been received. In response to the indication that the at least one first light signal 10 has been received, the processor determines if an encoded second light signal 20 should be transmitted. If the processor determines that an encoded second light signal 20 should be transmitted, the processor determines what information should be encoded on the second light signal.

The second apparatus 200 comprises means 220 for digitally encoding a light signal with information to form an encoded second light signal 20. In examples, the means 220 for digitally encoding a second light signal are configured to modulate the light signal to form an encoded second light signal 20. In examples, the second apparatus generates the light signal which is encoded to form the encoded second light signal.

The second apparatus comprises a light transmitter 230 for transmitting the encoded second light signal 20.

In some examples, the second apparatus 200 comprises more than one light transmitter 230 for transmitting more than one encoded second light signal 20.

FIGS. 18A-18C illustrate further examples of the second apparatus 200 as described in any of FIG. 3 or 15-17. Features not illustrated in FIGS. 18A-18C are illustrated in at least one of FIGS. 15-17.

In some examples in which a direction of arrival of the at least one first light signal 10 is determined, the light transmitter 230 is configured to transmit the encoded second light signal 20 using a direction of departure that is reciprocal to the direction of arrival of the at least one first light signal 10. In the example of FIG. 18B, the encoded light signal is transmitted using a direction of departure that is reciprocal to the direction of arrival of the at least one first light signal 10 of FIG. 18A.

In other examples, the light transmitter 230 is configured to transmit the encoded second light signal 20 in two or more directions. In the example of FIG. 18C, the encoded second light signal 20 is transmitted in multiple directions within a 180° range.

In some examples, the second apparatus 200 is a wearable device such as smart glasses, headphones, or another head-mounted device.

In examples, the second apparatus 200 is a device that is attachable to an object, for example any of the wearable devices described above or a car, a building or a statue. In examples, the object is the object associated with the second apparatus as described above. In some such examples, the second apparatus 200 is represented in the three-dimensional model 300 as the first object 310 and the object associated with the apparatus is represented in the three-dimensional model 300 as the second object. In other such examples, the second apparatus 200 is represented in the three-dimensional model 300 as the first object 310 and another object is represented in the three-dimensional model 300 as the second object.

FIG. 19 illustrates a system 190 comprising an apparatus 100 as described in any of FIGS. 1-14 and a second apparatus 200 as described in any of FIGS. 3, 15-18.

FIG. 20 illustrates an example of a method 700, the method 700 comprising:
at block 702, receiving at least one first light signal;
at block 704, digitally encoding a light signal with information to form an encoded second light signal; and
at block 706, transmitting the encoded second light signal.

FIG. 21 illustrates an example of a controller 600 suitable for use in an apparatus 200. Implementation of a controller 600 may be as controller circuitry. The controller 600 may be implemented in hardware alone, have certain aspects in software including firmware alone or can be a combination of hardware and software (including firmware).

As illustrated in FIG. 21 the controller 600 may be implemented using instructions that enable hardware functionality, for example, by using executable instructions of a computer program 606 in a general-purpose or special-purpose processor 602 that may be stored on a computer readable storage medium (disk, memory etc) to be executed by such a processor 602.

The processor 602 is configured to read from and write to the memory 604. The processor 602 may also comprise an output interface via which data and/or commands are output by the processor 602 and an input interface via which data and/or commands are input to the processor 602.

The memory 604 stores a computer program 606 comprising computer program instructions (computer program code) that controls the operation of the apparatus 200 when loaded into the processor 602. The computer program instructions, of the computer program 606, provide the logic and routines that enables the apparatus to perform the methods illustrated in the accompanying Figs. The processor 602 by reading the memory 604 is able to load and execute the computer program 606.

The apparatus 200 comprises:
at least one processor 602; and
at least one memory 604 including computer program code
the at least one memory 604 and the computer program code configured to, with the at least one processor 602, cause the apparatus 200 at least to perform:
   receiving at least one first light signal;
   encoding a light signal with information to form an encoded second light signal; and
   transmitting the encoded second light signal.

The apparatus 200 comprises:
at least one processor 602; and
at least one memory 604 storing instructions that, when executed by the at least one processor 602, cause the apparatus at least to:
receiving at least one first light signal;
encoding a light signal with information to form an encoded second light signal; and
transmitting the encoded second light signal.

As illustrated in FIG. 22, the computer program 606 may arrive at the apparatus 200 via any suitable delivery mechanism 608. The delivery mechanism 608 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 606. The delivery mechanism may be a signal configured to reliably transfer the computer program 606. The apparatus 200 may propagate or transmit the computer program 606 as a computer data signal.

Computer program instructions for causing an apparatus to perform at least the following or for performing at least the following:
receiving at least one first light signal;
encoding a light signal with information to form an encoded second light signal; and
transmitting the encoded second light signal.

The computer program instructions may be comprised in a computer program, a non-transitory computer readable medium, a computer program product, a machine readable medium. In some but not necessarily all examples, the computer program instructions may be distributed over more than one computer program.

Although the memory 604 is illustrated as a single component/circuitry it may be implemented as one or more separate components/circuitry some or all of which may be integrated/removable and/or may provide permanent/semi-permanent/dynamic/cached storage.

Although the processor 602 is illustrated as a single component/circuitry it may be implemented as one or more separate components/circuitry some or all of which may be integrated/removable. The processor 602 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The apparatus 100 can be a module. The apparatus 200 can be a module. Other functional components described can be modules.

The above-described examples find application as enabling components of:

automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic system 190s, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1-15. (canceled)

16. An apparatus comprising:
at least one processor; and
at least one memory storing instructions that, when executed by the at least one processor, cause the apparatus at least to:
transmit at least one first light signal;
receive the at least one first light signal;
receive at least one second light signal;
decode the at least one second light signal to obtain digital information encoded on the at least one second light signal;
perform a detection and ranging operation based on receiving the at least one first light signal;
in response to the detection and ranging operation, create a three-dimensional model;
display the three-dimensional model to a user of the apparatus; and
in response to the obtained digital information, decoded from the at least one second light signal, update the three-dimensional model.

17. An apparatus as claimed in claim 16, wherein the at least one memory and the instructions stored therein are configured to, with the at least one processor, further cause the apparatus to: provide a user interface, wherein the user interface is configured to receive user selection input of one or more objects in the three-dimensional model.

18. An apparatus as claimed in claim 16, wherein the at least one memory and the instructions stored therein are configured to, with the at least one processor, further cause the apparatus to: update the three-dimensional model in response to at least one of:
decoding the second light signal;
a determination that the three-dimensional model should be updated, the determination being based on a comparison of the information provided by the three-dimensional model and the obtained digital information; or
a detection of a user input to the apparatus.

19. An apparatus as claimed in claim 16, wherein the at least one memory and the instructions stored therein are configured to, with the at least one processor, further cause the apparatus to:
receive a plurality of second light signals with different directions of arrival;
decode the plurality of second light signals to obtain respective digital information; and
based on a direction of arrival of the respective second light signals, classify the obtained digital information into different groups.

20. An apparatus as claimed in claim 19, wherein the at least one memory and the instructions stored therein are configured to, with the at least one processor, further cause the apparatus to:
use at least one of time division multiplexing or frequency division multiplexing to classify the obtained digital information into the different groups.

21. An apparatus as claimed in claim 16, wherein the at least one memory and the instructions stored therein are configured to, with the at least one processor, further cause the apparatus to: use the obtained digital information to control creation of a bidirectional communication channel between the apparatus and another apparatus.

22. An apparatus as claimed in claim 16, wherein the at least one memory and the instructions stored therein are configured to, with the at least one processor, further cause the apparatus to: determine that a direction of arrival of the second light signal corresponds to a bearing of a first object in the three-dimensional model;
based upon the determination that the direction of arrival of the second light signal corresponds to the bearing of the first object, comprising of associating the digital information with the first object in the three-dimensional model, augment the three-dimensional model.

23. An apparatus as claimed in claim 22, wherein the at least one memory and the instructions stored therein are configured to, with the at least one processor, further cause the apparatus to: determine that a range of the second light signal corresponds to a position of the first object in the three-dimensional model;
based upon the determination that the range of the second light signal corresponds to the position of the first object and the determination that the direction of arrival of the second light signal corresponds to the bearing of the first object, comprising of associating the digital information with the first object in the three-dimensional model, augment the three-dimensional model.

24. An apparatus as claimed in claim 22, wherein the at least one memory and the instructions stored therein are configured to, with the at least one processor, further cause the apparatus to: determine that a bearing of a second object in the three-dimensional model corresponds to the bearing of the first object;
based upon the determination that the bearing of the second object corresponds to the bearing of the first object, comprising of associating the digital information with the second object in the three-dimensional model, augment the three-dimensional model.

25. An apparatus as claimed in claim 24, wherein the at least one memory and the instructions stored therein are configured to, with the at least one processor, further cause the apparatus to: determine that a position of the second object in the three-dimensional model corresponds to the position of the first object in the three-dimensional model;
based upon the determination that the position of the second object corresponds to the position of the first object and the determination that the bearing of the second object corresponds to the bearing of the first object, comprising of associating the digital information with the second object in the three-dimensional model, augment the three-dimensional model.

26. An apparatus as claimed in claim 22, wherein the at least one memory and the instructions stored therein are configured to, with the at least one processor, further cause the apparatus to: selectively adapt at least one of the first object or the second object.

27. An apparatus as claimed in claim 26, wherein selectively adapting at least one of the first object or the second object comprises:
determining that an alternative three-dimensional representation of the at least one of the first object or the second object is available for download;
downloading the alternative three-dimensional representation of the at least one of the first object or the second object; and
augmenting the three-dimensional model by placing the alternative three-dimensional representation of the at least one of the first object or the second object in the three-dimensional model.

28. An apparatus as claimed in claim 26, wherein selectively adapting at least one of the first object or the second object comprises:
removing at least a portion of at least one of the first object or the second object from the three-dimensional model.

29. An apparatus as claimed in claim 26, wherein selectively adapting at least one of the first object or the second object comprises: obscuring at least a portion of at least one of the first object or the second object in the three-dimensional model.

30. A method comprising:
transmitting at least one first light signal;
receiving the at least one first light signal;
receiving at least one second light signal;
decoding the at least one second light signal to obtain digital information encoded on the at least one second light signal;
performing a detection and ranging operation based on receiving the at least one first light signal;
in response to the detection and ranging operation, creating a three-dimensional model;
displaying the three-dimensional model to a user of the apparatus; and
in response to the obtained digital information, decoded from the at least one second light signal, updating the three-dimensional model.

31. A method as claimed in claim 30, further comprising:
determining that a direction of arrival of the second light signal corresponds to a bearing of a first object in the three-dimensional model;
based upon the determination that the direction of arrival of the second light signal corresponds to the bearing of the first object, comprising of associating the digital information with the first object in the three-dimensional model, augmenting the three-dimensional model.

32. A method as claimed in claim 31, further comprising:
selectively adapting at least one of the first object or the second object.

33. A method as claimed in claim 32, wherein selectively adapting at least one of the first object or the second object comprises at least one of:
removing at least a portion of at least one of the first object or the second object from the three-dimensional model; or
obscuring at least a portion of at least one of the first object or the second object in the three-dimensional model.

34. A non-transitory computer readable medium comprising program instructions stored thereon for causing an apparatus to perform at least the following:
transmitting at least one first light signal;
receiving the at least one first light signal;
receiving at least one second light signal;
decoding the at least one second light signal to obtain digital information encoded on the at least one second light signal;
performing a detection and ranging operation based on receiving the at least one first light signal;
in response to the detection and ranging operation, creating a three-dimensional model;
displaying the three-dimensional model to a user of the apparatus; and
in response to the obtained digital information, decoded from the at least one second light signal, updating the three-dimensional model.

35. The non-transitory computer readable medium of claim 34, wherein the computer program code is further configured to cause the apparatus to: use the obtained digital information to control creation of a bidirectional communication channel between the apparatus and another apparatus.
